(19) United States
(12) Patent Application Publication
(10) Pub. No.: US 2010/0005634 A1
(43) Pub. Date: Jan. 14, 2010

(54) Elastic clipping structure

(76) Inventors: Cheng-Hsiung Kuo, Jhonghe City (TW); Yu-Yang Liu, Taipei City (TW); Ming-Chung Huang, Sindian City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/216,562

(22) Filed: Jul. 8, 2008

(51) Int. Cl. F16B 2/20

(52) U.S. Cl. 24/455

(57) ABSTRACT

The elastic clipping structure includes a body unit and an elastic unit. The body unit has a body portion, a clipping portion disposed on a first lateral side of the body portion, and an opening forming on a second lateral side of the body portion. The elastic unit has an elastic body with a U shape. The elastic body is disposed on the body portion, and the elastic body has an abutting portion abutted against the clipping portion and two movable portions passing through the opening. Therefore, the body unit and the elastic unit are mated to each other, so that when two opposite forces are acting on two opposite sides of the elastic unit, the elastic unit is compressed inwards. When the two opposite forces are released from the elastic unit, the elastic unit is restored to its original restriction position by the restriction portion.

### BACKGROUND OF THE INVENTION

1. Field of the Invention

The present invention relates to an elastic clipping structure, and particularly relates to an elastic clipping structure that can be compressed inwards by acting an external force and can be restored to its original restriction position by releasing the external force.

2. Description of the Related Art

A clip is a connection element to connect at least two elements together, whereby one element can be movable and the other element can be fixed. In such a case, the movable element can be retained or positioned on the fixed element using a clip.

In the prior art, the clip is used widely. For example, a clip is applied to a lamp holder such as U.S. Pat. Nos. 5,653,412 and 6,068,389 etc. A light-emitting element (movable element) can be fixed on a wall (fixed element) by using a clip as shown in FIG. 7 of the U.S. Pat. No. 5,653,412. A light-emitting element (movable element) can be fixed on a casing (fixed element) by using a clip as shown in FIGS. 1 to 3 of the U.S. Pat. No. 6,068,389.

However, the clip of the prior art has some defects. For example, although the structure of the clip of U.S. Pat. No. 5,653,412 is simple, the position capability of the clip is bad. Hence, the clip cannot effectively position the light-emitting element for a along time, and the light-emitting element is easily separated from the clip. Moreover, although the position capability of the clip of U.S. Pat. No. 5,653,412 is better, the structure of the clip is complex. Hence, the manufacturing cost and the manufacturing time of the clip are high.

### SUMMARY OF THE INVENTION

The present invention provides an elastic clipping structure. The elastic clipping structure has a body unit and an elastic unit mated to each other, so that when two opposite forces are acting on two opposite sides of the elastic unit, the elastic unit is compressed inwards; When the two opposite forces are released from the elastic unit, the elastic unit is restored to its original restriction position by the restriction portion.

A first aspect of the invention is an elastic clipping structure, including: a body unit and an elastic unit. The body unit has a body portion, a clipping portion disposed on a first lateral side of the body portion, and an opening forming on a second lateral side of the body portion. The elastic unit has an elastic body. The elastic body is disposed on the body portion, and the elastic body has an abutting portion abutted against the clipping portion and two movable portions passing through the opening.

A second aspect of the invention is an elastic clipping structure, including: a body unit and an elastic unit. The body unit has a body portion, a retaining portion disposed on a first lateral side of the body portion, and an opening forming on a second lateral side of the body portion. The elastic unit has two elastic main bodies. Each elastic body is disposed on the body portion, and each elastic body has a fixing portion fixed in the retaining portion and a movable portion passing through the opening.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objects and advantages of the present invention will be more readily understood from the following detailed description when read in conjunction with the appended drawings, in which:

FIG. 1A is a first perspective, schematic view of an elastic clipping structure according to the first embodiment of the present invention;

FIG. 1B is a second perspective, schematic view of an elastic clipping structure according to the first embodiment of the present invention;

FIG. 1C is a top, schematic view of an elastic clipping structure according to the first embodiment of the present invention;

FIG. 1D is a lateral, schematic view of an elastic clipping structure applied to a predetermined object according to the first embodiment of the present invention;

FIG. 2A is a first perspective, schematic view of an elastic clipping structure according to the second embodiment of the present invention; and

FIG. 2B is a second perspective, schematic view of an elastic clipping structure according to the second embodiment of the present invention.

### DETAILED DESCRIPTION OF PREFERRED EMBODIMENTS

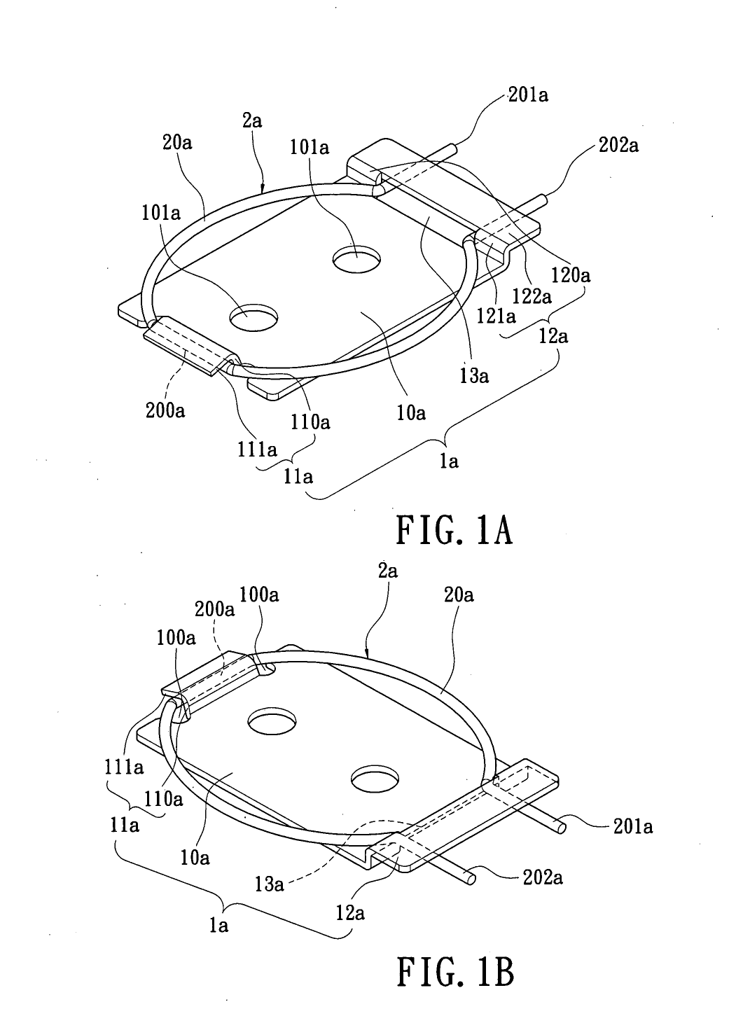

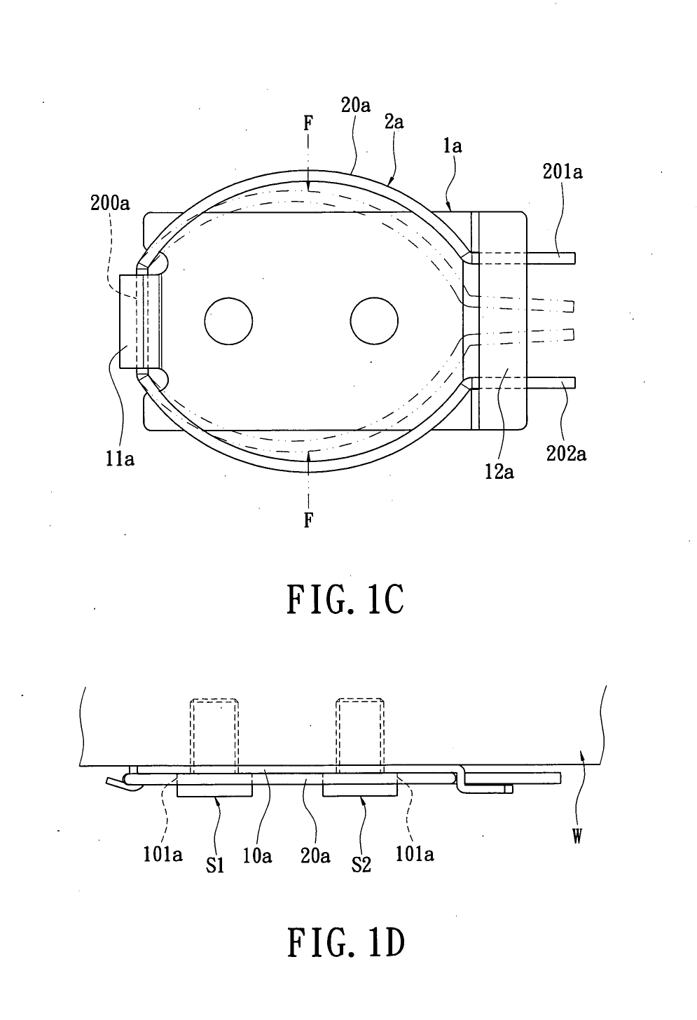

Referring to FIGS. 1A to 1D, the present invention of the first embodiment provides an elastic clipping structure, including: a body unit 1a and an elastic unit 2a.

The body unit 1a has a body portion 10a, a clipping portion 11a disposed on a first lateral side of the body portion 10a, a restriction portion 12a disposed on a second lateral side of the body portion 10a, and an opening 13a forming on the second lateral side of the body portion 10a. The opening 13a is formed between the body portion 10a and the restriction portion 12a. In the first embodiment, the body portion 10a, the clipping portion 11a and the restriction portion 12a are integratedly formed together to form a rigid body. The rigid body can be made of rigid metal or nonmetal material.

Moreover, the first lateral side of the body portion 10a is located opposite to the second lateral side of the body portion 10a. The body portion 10a has two notches 100a respectively close to two lateral sides of the clipping portion 11a in order to easily bend the clipping portion 11a for manufacturer. The shape of the clipping portion 11a can be L-shaped, and the clipping portion 11a is inclined relative to the body portion 10a by a predetermined angle. In addition, the clipping portion 11a has a bending portion 110a inclined relative to the body portion 10a by the predetermined angle and an extending portion 111a forwards extended from the bending portion 110a. The restriction portion 12a has two first bending portions (120a, 121a) upwards bent from the body portion 10a and a second bending portion 122a forwards bent from the two first bending portions (120a, 121a).

Furthermore, the elastic unit 2a has an elastic body 20a with a U-shape. The elastic body 20a is disposed on the body portion 10a, and the elastic body 20a has an abutting portion 200a abutted against the clipping portion 11a and two movable portions (201a, 202a) passing through the opening 13a. In addition, the abutting portion 200a is abutted against between the bending portion 110a of the clipping portion 11a and the extending portion 111a. The two movable portions (201a, 202a) are respectively restricted to move left and right by the two first bending portions (120a, 121a), and the two movable portions (201a, 202a) are restricted to move upward and downward by mating the second bending portion 122a and the body portion 10a.

Referring to FIG. 1C, the body unit 1a and the elastic unit 2a are mated to each other, so that when two opposite forces F (as arrows shown in FIG. 1C) are acting on two opposite sides of the elastic unit 2a, the elastic unit 2a is compressed inwards as the phantom line in FIG. 1C; When the two opposite forces F are released from the elastic unit 2a, the elastic unit 2a is restored to its original restriction position by the restriction portion 12a. In other words, the elastic body 20a with a U-shape is selectively compressed inwards (when the two opposite forces F are acting on the elastic unit 2a) or restored to the original restriction position (when the two opposite forces F are released from the elastic unit 2a). Of course, the two opposite forces F can be replaced into a single force F on one side of the elastic body 20a of the elastic unit 2a.

Referring to FIGS. 1A, 1C and 1D, the body portion 10a has at least two through holes 101a. Two screw elements (S1, S2) respectively pass through the at least two through holes 101a in order to fix the body portion 10a on a predetermined object W. For example, the body portion 10a can be fixed on a lamp frame (not shown) of ceiling by matching the two screw elements (S1, S2) and the at least two through holes 101a, and then the elastic body 20a is compressed inwards as the phantom line in FIG. 1C and received into a retaining groove of the lamp frame (the size of the elastic body 20a is reduced in order to adapt to the retaining groove of the lamp frame). Finally, the compressed elastic body 20a is released and restored to the original restriction position by the restriction portion 12a, so that the elastic body 20a can be positioned in the retaining groove of the lamp frame. Hence, a lamp holder with one or many light-emitting elements can be retained in a stable manner on a lamp frame of ceiling by the elastic body 20a. However, above-mentioned application of the elastic clipping structure does not use to limit the present invention. In other words, the elastic clipping structure can mate with any retaining structure in order to retain any lamp holder such as decoration lamp holder on any position that user wants.

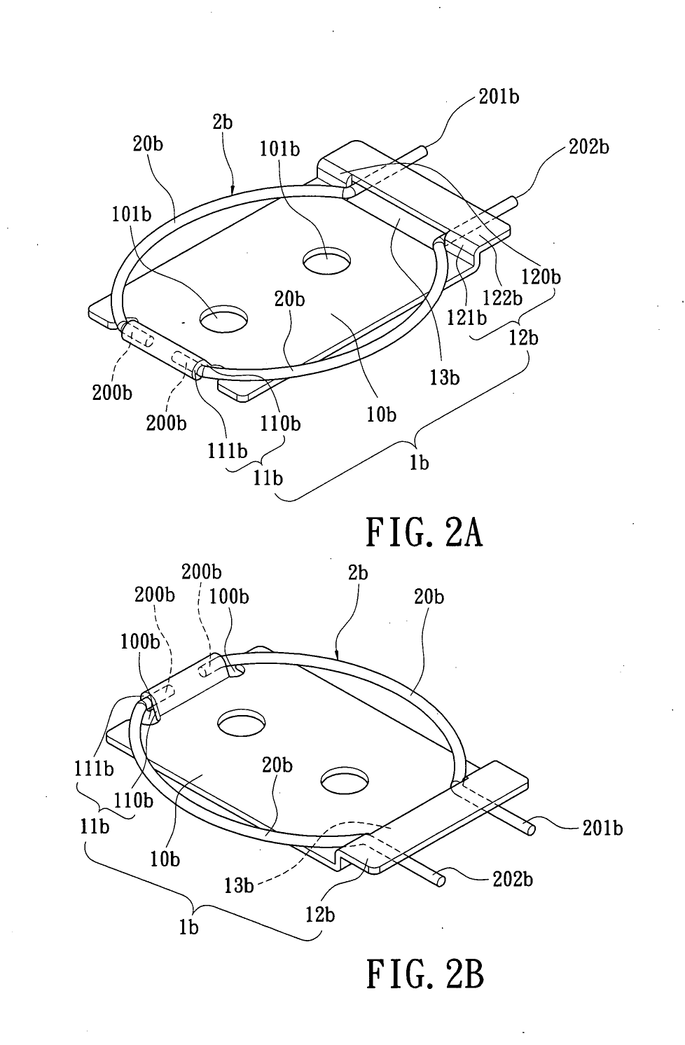

Referring to FIGS. 2A and 2B, the present invention of the second embodiment provides an elastic clipping structure, including: a body unit 1b and an elastic unit 2b.

The body unit 1b has a body portion 10b, a retaining portion 11b disposed on a first lateral side of the body portion 10b, a restriction portion 12b disposed on a second lateral side of the body portion 10b, and an opening 13b forming on the second lateral side of the body portion 10b. The opening 13b is formed between the body portion 10b and the restriction portion 12b. In the first embodiment, the body portion 10b, the retaining portion 11b and the restriction portion 12b are integratedly formed together to form a rigid body. The rigid body can be made of rigid metal or nonmetal material.

Moreover, the first lateral side of the body portion 10b is located opposite to the second lateral side of the body portion 10b. The body portion 10b has two notches 100b respectively close to two lateral sides of the retaining portion 11b in order to easily bend the retaining portion 11b for manufacturer. The retaining portion 11b can be C-shaped, and the retaining portion 11b is inclined relative to the body portion 10b by a predetermined angle. In addition, the retaining portion 11b has a bending portion 110b inclined relative to the body portion 10b by the predetermined angle and an extending portion 111b forwards extended from the bending portion 110b. The restriction portion 12b has two first bending portions (120b, 121b) upwards bent from the body portion 10b and a second bending portion 122b forwards bent from the two first bending portions (120b, 121b).

Furthermore, the elastic unit 2b has two elastic main bodies 20b. The two elastic main bodies 20b are disposed on the body portion 10b. One of the two elastic main bodies 20b has a fixing portion 200b fixed in the retaining portion 11b and a movable portion 201b passing through the opening 13b, the other elastic body 20b has a fixing portion 200b fixed in the retaining portion 11b and a movable portion 202b passing through the opening 13b. In addition, the fixing portion 200a is fixed between the bending portion 110b of the retaining portion 11b and the extending portion 111b. The two movable portions (201b, 202b) are respectively restricted to move left and right by the two first bending portions (120b, 121b), and the two movable portions (201b, 202b) are restricted to move upward and downward by mating the second bending portion 122b and the body portion 10b.

In addition, the body unit 1b and the elastic unit 2b are mated to each other, so that when two opposite forces (not shown) are acting on two opposite sides of the elastic unit 2b, the elastic unit 2b is compressed inwards as the phantom line in FIG. 1C; When the two opposite forces are released from the elastic unit 2b, the elastic unit 2b is restored to its original restriction position by the restriction portion 12b. In other words, the elastic body 20b is selectively compressed inwards (when the two opposite forces are acting on the elastic unit 2b) or restored to the original restriction position (when the two opposite forces are released from the elastic unit 2b). Of course, the two opposite forces can be replaced into a single force on one side of the elastic body 20b of the elastic unit 2b.

In conclusion, the present invention has following advantages:

1. The body unit and the elastic unit are mated to each other, so that when two opposite forces are acting on two opposite sides of the elastic unit, the elastic unit is compressed inwards as the phantom line in FIG. 1C; When the two opposite forces are released from the elastic unit, the elastic unit is restored to its original restriction position by the restriction portion.

2. The body portion can be fixed on a lamp frame of ceiling by matching the two screw elements and the at least two through holes, and then the elastic body is compressed inwards and received into a retaining groove of the lamp frame (the size of the elastic body is reduced in order to adapt to the retaining groove of the lamp frame). Finally, the compressed elastic body is released and restored to the original restriction position by the restriction portion, so that the elastic body can be positioned in the retaining groove of the lamp frame.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An elastic clipping structure, comprising:
a body unit having a body portion, a clipping portion disposed on a first lateral side of the body portion, and an opening forming on a second lateral side of the body portion; and
an elastic unit having an elastic body, wherein the elastic body is disposed on the body portion, and the elastic body has an abutting portion abutted against the clipping portion and two movable portions passing through the opening.

2. The elastic clipping structure as claimed in claim 1, wherein the shape of the elastic body is U-shaped, and the first lateral side is located opposite to the second lateral side.

3. The elastic clipping structure as claimed in claim 1, wherein the body portion has at least two through holes, and two screw elements respectively pass through the at least two through holes in order to fix the body portion on a predetermined object.

4. The elastic clipping structure as claimed in claim 1, wherein the body portion has two notches respectively close to two lateral sides of the clipping portion.

5. The elastic clipping structure as claimed in claim 1, wherein the clipping portion is inclined relative to the body portion by a predetermined angle.

6. The elastic clipping structure as claimed in claim 5, wherein the clipping portion has a bending portion inclined relative to the body portion by the predetermined angle and an extending portion forwards extended from the bending portion, and the abutting portion is abutted against between the bending portion and the extending portion.

7. The elastic clipping structure as claimed in claim 1, wherein the body unit further comprises a restriction portion disposed on the second lateral side of the body portion, and the opening is formed between the body portion and the restriction portion.

8. The elastic clipping structure as claimed in claim 7, wherein the body portion, the clipping portion and the restriction portion are integratedly formed together to form a rigid body.

9. The elastic clipping structure as claimed in claim 7, wherein the restriction portion has two first bending portions upwards bent from the body portion and a second bending portion forwards bent from the two first bending portions.

10. The elastic clipping structure as claimed in claim 9, wherein the two movable portions are respectively restricted to move left and right by the two first bending portions, and the two movable portions are restricted to move upward and downward by mating the second bending portion and the body portion.

11. An elastic clipping structure, comprising:
a body unit having a body portion, a retaining portion disposed on a first lateral side of the body portion, and an opening forming on a second lateral side of the body portion; and
an elastic unit having two elastic main bodies, wherein each elastic body is disposed on the body portion, and each elastic body has a fixing portion fixed in the retaining portion and a movable portion passing through the opening.

12. The elastic clipping structure as claimed in claim 11, wherein the first lateral side is located opposite to the second lateral side.

13. The elastic clipping structure as claimed in claim 11, wherein the body portion has at least two through holes, and two screw elements respectively pass through the at least two through holes in order to fix the body portion on a predetermined object.

14. The elastic clipping structure as claimed in claim 11, wherein the body portion has two notches respectively close to two lateral sides of the retaining portion.

15. The elastic clipping structure as claimed in claim 11, wherein the retaining portion is inclined relative to the body portion by a predetermined angle.

16. The elastic clipping structure as claimed in claim 15, wherein the retaining portion has a bending portion inclined relative to the body portion by the predetermined angle and an extending portion forwards extended from the bending portion, and the fixing portion is fixed between the bending portion and the extending portion.

17. The elastic clipping structure as claimed in claim 11, wherein the body unit further comprises a restriction portion disposed on the second lateral side of the body portion, and the opening is formed between the body portion and the restriction portion.

18. The elastic clipping structure as claimed in claim 17, wherein the body portion, the retaining portion and the restriction portion are integratedly formed together to form a rigid body.

19. The elastic clipping structure as claimed in claim 17, wherein the restriction portion has two first bending portions upwards bent from the body portion and a second bending portion forwards bent from the two first bending portions.

20. The elastic clipping structure as claimed in claim 19, wherein the two movable portions are respectively restricted to move left and right by the two first bending portions, and the two movable portions are restricted to move upward and downward by mating the second bending portion and the body portion.
